(19) United States
(12) Patent Application Publication
(10) Pub. No.: US 2005/0244605 A1
(43) Pub. Date: Nov. 3, 2005

(54) Use of an adhesive for assembling a member and a wheel, a member-and-wheel assembly, a member, and a wheel

(75) Inventors: Salima Fahas, Mozac (FR); Frederic Leymin, Clermont-Ferrand (FR)

Correspondence Address: James R. Williams;Jamison, Seltzer, Harper & Williams, 2625 Wilmington Road, New Castle, PA, 16105, US

(73) Assignees: Michelin Recherche et Technique S.A., Granges-Paccot (CH); TRW Automotive US, LLC, Farmington Hills, MI (US)

(21) Appl. No.: 11/067,608

(22) Filed: Feb. 25, 2005

(30) Foreign Application Priority Data
Feb. 27, 2004 (FR) 0402045

(51) Int. Cl. B32B 9/00

(52) U.S. Cl. 428/66.7

(57) ABSTRACT

The invention relates to the use of an adhesive for assembling together a member and a wheel, the adhesive presenting the following properties: the breaking stress in traction of the adhesive is greater than 0.5 MPa at 80° C.; the adhesive comprises at least one polymeric component of vitreous transition temperature below −50° C.; and the adhesive comprises at least one other polymeric component of vitreous transition temperature above 100° C.

The present invention relates to the use of an adhesive for assembling a member and a wheel, to a member-and-wheel assembly, to a member, and to a wheel.

### BACKGROUND OF THE INVENTION

Car manufacturers are equipping the wheels of vehicles more and more frequently with members having the function of providing information about the tires to a vehicle computer.

Amongst possible members, there are to be found, for example, pressure sensors, temperature sensors, and devices for identifying tires.

Long-term fixing of a member to a wheel is a problem that is difficult to solve, given the stresses to which the member is subjected. In particular, the member is subjected to very high accelerations, due in particular to centrifugal force, and it is also subjected to temperature variations of very large amplitude.

In the state of the art, various methods are known for assembling a pressure sensor to a wheel.

A first known technique consists in integrating the pressure sensor with a tire inflation valve placed on the wheel. Nevertheless, the extra weight due to the pressure sensor can weaken the valve, and as a result, the value runs the risk, little by little, of ceasing to be airtight.

A second known technique consists in placing the pressure sensor in an assembly groove of the wheel and in fixing it by means of a clamping collar that surrounds the assembly groove of the wheel circumferentially. However, the clamping force exerted by the collar decreases over time, and slack tends to appear between the pressure sensor and the wheel.

### OBJECTS AND SUMMARY OF THE INVENTION

An object of the invention is to propose a simpler and more effective alternative to those fixing methods, by assembling a member and a wheel by means of an adhesive which withstands those various above-mentioned stresses.

To this end, the invention provides the use of an adhesive for assembling together a member and a wheel, the adhesive presenting the following properties:

the breaking stress in traction of the adhesive is greater than 0.5 megapascals (MPa) at 80° C.; and

the adhesive comprises at least one polymeric component of vitreous transition temperature below −50° C.

The invention thus makes it possible to assemble a member to a wheel in a manner that is simple, fast, and effective. Because of the properties of the adhesive, cohesion of the assembly is ensured under all normal conditions of use of a wheel.

The inventors have found that using an adhesive of the invention enables a pressure sensor weighing 75 grams (g) to be fixed to a wheel up to speeds of 300 kilometers per hour (km/h) for periods of 2 hours (h) and for temperatures lying in the range −30° C. to 120° C.

Because of its viscous nature, the adhesive also presents the advantage of filling in any interstices that might exist between the member and the wheel, thus making it possible in particular to fix members of identical shape on wheels of different diameters, thereby reducing the costs involved in designing, manufacturing, and managing a plurality of members of different dimensions.

The use of an adhesive of the invention may additionally comprise one or more of the following characteristics:

the polymeric component belongs to the group of styrene butadiene rubbers (SBRs) and polybutadienes;

the adhesive comprises at least one other polymeric component of vitreous transition temperature above 100° C.;

the other polymeric component is obtained by condensing an epoxy resin;

the member is assembled on the radially-outer surface of an assembly groove of the wheel;

the member is selected from at least one of the elements in the set comprising: a transmitter, a receiver, a sensor, a pressure sensor, a temperature sensor, and a support for any of the preceding elements;

the member is a support for any of the above-specified elements, the element being secured to the support by snap-fastening; and

the member is a support for any of the above-specified elements, the support including a housing for receiving the element by insertion in an insertion direction that is substantially orthoradial when the support is bonded to the wheel, i.e. a direction substantially perpendicular to a radius of the wheel and passing through the center of the support.

The invention also provides an assembly of a member and a wheel assembled together by means of an adhesive, wherein the adhesive presents the following properties:

the breaking stress in traction of the adhesive is greater than 0.5 MPa at 80° C.; and

the adhesive comprises at least one polymeric component of vitreous transition temperature below −50° C.

An assembly of the invention may further comprise one or more of the following characteristics:

the polymeric component belongs to the group of SBRs and polybutadienes;

the adhesive comprises at least one other polymeric component of vitreous transition temperature above 100° C.;

the other polymeric component is obtained by condensing an epoxy resin;

the member is assembled on the radially-outer surface of an assembly groove of the wheel;

the member is selected from at least one of the elements in the set comprising: a transmitter, a receiver, a sensor, a pressure sensor, a temperature sensor, and a support for any of the preceding elements;

the member is a support for any of the above-specified elements, the element being secured to the support by snap-fastening; and

the member is a support for any of the above-specified elements, the support including a housing for receiving the element by insertion in an insertion direction that is substantially orthoradial when the support is bonded to the wheel.

The invention also provides a member for securing to a wheel, the member including a precoated layer of an adhesive presenting the following properties:

the breaking stress in traction of the adhesive is greater than 0.5 MPa at 80° C.; and

the adhesive comprises at least one polymeric component of vitreous transition temperature below −50° C.

The member of the invention may further comprise one or more of the following characteristics:

the polymeric component belongs to the group of SBRs and polybutadienes;

the adhesive comprises at least one other polymeric component of vitreous transition temperature above 100° C.;

the other polymeric component is obtained by condensing an epoxy resin;

the member is selected from at least one of the elements in the set comprising: a transmitter, a receiver, a sensor, a pressure sensor, a temperature sensor, and a support for any of the preceding elements;

the member is a support for any of the above-specified elements, the element being secured to the support by snap-fastening;

the member is a support for any of the above-specified elements, the support including a housing for receiving the element by insertion in an insertion direction that is substantially orthoradial when the support is secured to the wheel; and

the member weighs 15 g to 90 g.

The invention also provides a wheel for receiving a member, the wheel including a precoated layer of adhesive presenting the following properties:

the breaking stress in traction of the adhesive is greater than 0.5 MPa at 80° C.; and

the adhesive comprises at least one polymeric component of vitreous transition temperature below −50° C.

A wheel of the invention may further comprise one or more of the following characteristics:

the polymeric component belongs to the group of SBRs and polybutadienes;

the adhesive comprises at least one other polymeric component of vitreous transition temperature above 100° C.;

the other polymeric component is obtained by condensing an epoxy resin; and

the precoated layer of adhesive is carried by the radially-outer surface of an assembly groove of the wheel.

The invention also provides a method of assembling an assembly comprising a wheel, a member, and a tire, the method comprising the following steps:

a first step of using an adhesive to assemble the member and the wheel in accordance with the above-defined invention; and

a second step of assembling the tire on the wheel carrying the member;

wherein the two steps are separated by a duration that is predetermined in such a manner that the adhesive bond is sufficiently strong during the second step.

An assembly method of the invention may include one or more of the following characteristics:

the predetermined duration lies in the range 45 seconds to 55 seconds; and

the wheel fitted with the member is stored temporarily between the two steps.

### BRIEF DESCRIPTION OF THE DRAWINGS

The invention will be better understood on reading the following description given purely by way of example and made with reference to the accompanying drawing, in which:

FIG. 1 is a diagrammatic radial section view of an assembly comprising a wheel and a member assembled together by means of an adhesive of the invention;

FIG. 2 is a diagrammatic longitudinal section view of the assembly shown in FIG. 1;

FIG. 3 is a diagram showing a detail of FIG. 1;

FIG. 4 is a diagram of a support for being bonded with adhesive to a wheel in a first embodiment; and

FIG. 5 is a diagram of a support for being bonded to a wheel with adhesive in a second embodiment.

### MORE DETAILED DESCRIPTION

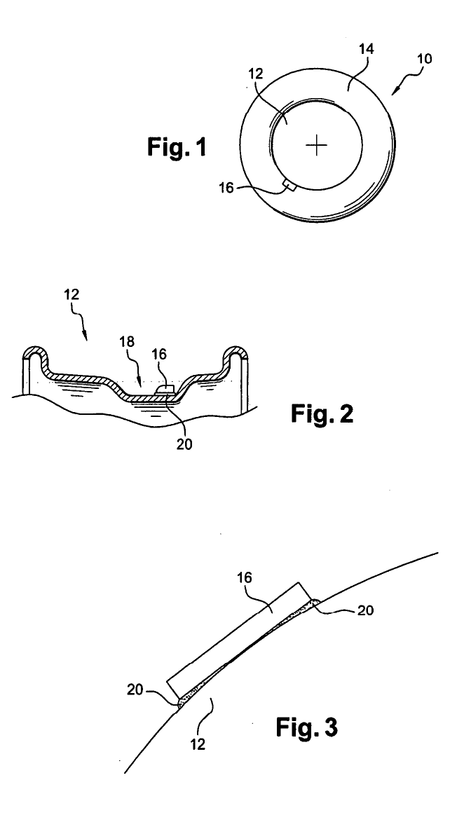

FIG. 1 shows an assembly designated by overall reference 10 and comprising a wheel 12 and a tire 14.

By way of example, the wheel is made of cast aluminum alloy with a covering of epoxy or polyester.

A member 16 is fixed to the periphery of the wheel 12. In the example shown in FIGS. 1 to 3, the member 16 is a pressure sensor 16 for sensing the pressure in the tire 14, however the invention can apply to any type of member, and in particular the member may serve to support a sensor.

The pressure sensor 16 is positioned on the radially-outer surface of an assembly groove 18 in the wheel 12, as shown in FIG. 2.

The pressure sensor is assembled to the wheel by means of a layer 20 of adhesive presenting the following properties:

the breaking stress in traction of the adhesive is greater than 0.5 MPa at 80° C., preferably greater than 1 MPa; and

the adhesive includes at least one polymeric component of vitreous transition temperature below −50° C., and preferably below −60° C.

The polymeric component may be a polymer belonging to the group of SBRs and polybutadienes.

The vitreous transition temperature (“Tg”) of a polymer is the temperature at which the mechanical behavior of the polymer changes from rigid and brittle vitreous behavior to rubbery behavior.

In its vitreous state, a polymer has very good traction strength but poor ability to withstand impacts and vibration.

A polymer in its rubbery state is good at withstanding impacts and vibration.

At a normal temperature of use, i.e. in the range −30° C. to 120° C., the polymeric component of Tg below −50° C. in the adhesive of the invention is in its rubbery state. The adhesive can thus damp vibration and impacts that occur while the wheel is in rotation.

The traction strength of the adhesive is obtained by means of another polymeric component of vitreous transition temperature above 100° C., and preferably above 120° C., e.g. obtained by condensing an epoxy resin.

This other polymeric component, which is in its vitreous state at normal temperatures of use provides the adhesive with its traction strength.

In order to ensure that the properties of both components are conserved in the adhesive, it is important to ensure that the two components are not thoroughly mixed together, i.e. the component should present two-phase behavior. To achieve such a two-phase mixture, the polymeric phase of vitreous transition temperature below −50° C. can be constituted by nodules of diameter greater than 150 micrometers (μm).

The epoxy elastomer adhesive 7240 from the supplier 3M satisfies the above characteristics. The inventors of the present invention have performed centrifuge tests on an assembly comprising a wheel and a pressure sensor assembled together by means of that adhesive and they have found that the adhesive at an initial temperature of 20° C. withstands 2 h centrifuging at 250 km/h, followed by 2 h at 300 km/h, followed by 2 h at 250 km/h. The wheel and sensor assemblies have also withstood temperature cycling between −30° C. and 120° C. under stress from the centrifuge.

The pressure sensor used during testing weighed about 75 g, while the sensors in common use generally weigh 15 g to 90 g.

FIG. 3 shows a pressure sensor 16 stuck to a wheel 12, the sensor being substantially rectangular in longitudinal section. It is then found that because of its viscosity the adhesive serves to fill in the interstices that appear at the end of the sensor between the sensor and the wheel due to the curvature of the wheel. This property enables a sensor to be stuck to wheels of different diameters.

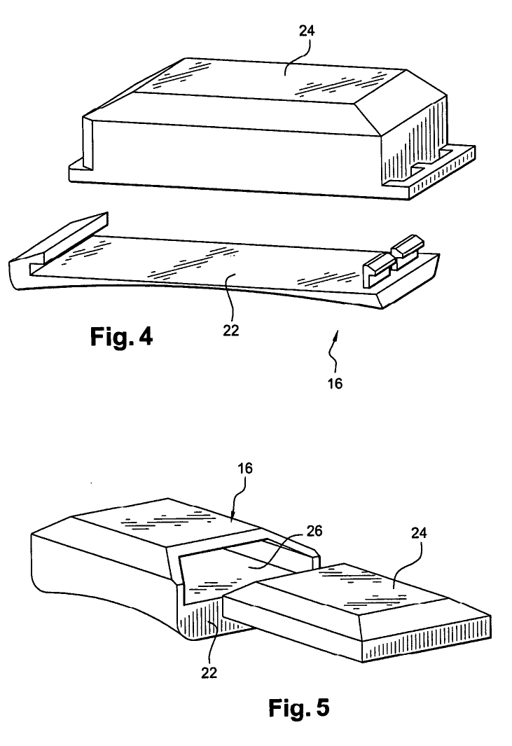

In a variant shown in FIGS. 4 and 5, the member 16 which is bonded to the wheel by means of adhesive, is a support 22 for a sensor 24. The support 22 presents curvature that is substantially equal to the curvature to the wheel.

In a first embodiment of the support, as shown in FIG. 4, the sensor 24 is secured to the support 22 by snap-fastening.

In a second embodiment of the support, as shown in FIG. 5, the support 22 has a housing 26 for receiving the sensor 24 by insertion in an insertion direction that is substantially orthoradial when the support 22 is bonded to the wheel. In this way, the sensor is secured in the support in a manner that withstands the centrifugal force due to the wheel rotating.

By way of example, the sensor 24 is inserted into the housing by being caused to slide with the help of guide means shaped on the support and on the sensor.

The adhesive may be applied between the member and the wheel at the time of assembly or it may be precoated on one or other of the two parts to be stuck together. It is thus possible, for example, to coat adhesive initially on the member, while protecting the coating of adhesive with a peel-off plastics film.

The assembly comprising the wheel, the sensor, and the tire is assembled in a first step by bonding the sensor to the wheel with adhesive, in a second step by mounting the tire on the wheel carrying the sensor, and in a third step by inflating the tire and balancing the wheel-and-tire assembly.

The adhesive takes about 50 seconds to cure, so it is advantageous for the first two steps to be spaced apart by a duration that is substantially equal to 50 seconds so as to ensure that the adhesive withstands mounting of the tire and the rotation that is needed in order to balance the wheel-and-tire assembly.

Since assembling the tire onto the wheel takes about 7 seconds, wheels carrying their respective sensors are stored temporarily between the first two steps. This temporary storage can be implemented, for example, by means of a conveyor transporting the wheels carrying their sensors from the adhesive bonding station to the station for assembling the tire, and by ensuring that this conveyor operation takes about 50 seconds.

1. The use of an adhesive for assembling together a member and a wheel, the adhesive presenting the following properties:
the breaking stress in traction of the adhesive is greater than 0.5 MPa at 80° C.;
the adhesive comprises at least one polymeric component of vitreous transition temperature below −50° C.; and
the adhesive comprises at least one other polymeric component of vitreous transition temperature above 100° C.

2. The use of an adhesive according to claim 1, in which the polymeric component belongs to the group of SBRs and polybutadienes.

3. The use of an adhesive according to claim 1, in which the other polymeric component is obtained by condensing an epoxy resin.

4. The use of an adhesive according to claim 1, in which the member is assembled on the radially-outer surface of an assembly groove of the wheel.

5. The use of an adhesive according to claim 1, in which the member is selected from at least one of the elements in the set comprising: a transmitter, a receiver, a sensor, a pressure sensor, a temperature sensor, and a support for any of the preceding elements.

6. The use of an adhesive according to claim 5, in which the member is a support for any of the above-specified elements, the element being secured to the support by snap-fastening.

7. The use of an adhesive according to claim 5, in which the member is a support for any of the above-specified elements, the support including a housing for receiving the element by insertion in an insertion direction that is substantially orthoradial when the support is bonded to the wheel.

8. An assembly of a member and a wheel assembled together by means of an adhesive, wherein the adhesive presents the following properties:
the breaking stress in traction of the adhesive is greater than 0.5 MPa at 80° C.;
the adhesive comprises at least one polymeric component of vitreous transition temperature below −50° C.; and
the adhesive comprises at least one other polymeric component of vitreous transition temperature above 100° C.

9. An assembly of a member and a wheel according to claim 8, in which the polymeric component belongs to the group of SBRs and polybutadienes.

10. An assembly of a member and a wheel according to claim 8, in which the other polymeric component is obtained by condensing an epoxy resin.

11. An assembly of a member and a wheel according to claim 8, in which the member is assembled on the radially-outer surface of an assembly groove of the wheel.

12. An assembly of a member and a wheel according to claim 8, in which the member is selected from at least one of the elements in the set comprising: a transmitter, a receiver, a sensor, a pressure sensor, a temperature sensor, and a support for any of the preceding elements.

13. An assembly of a member and a wheel according to claim 12, in which the member is a support for any of the above-specified elements, the element being secured to the support by snap-fastening.

14. An assembly of a member and a wheel according to claim 12, in which the member is a support for any of the above-specified mentioned elements, the support including a housing for receiving the element by insertion in an insertion direction that is substantially orthoradial when the support is bonded to the wheel.

15. A member for securing to a wheel, the member including a precoated layer of an adhesive presenting the following properties:
the breaking stress in traction of the adhesive is greater than 0.5 MPa at 80° C.;
the adhesive comprises at least one polymeric component of vitreous transition temperature below −50° C.; and
the adhesive comprises at least one other polymeric component of vitreous transition temperature above 100° C.

16. A member according Lo claim 15, in which the polymeric component belongs to the group of SBRs and polybutadienes.

17. A member according to claim 15, in which the other polymeric component is obtained by condensing an epoxy resin.

18. A member according to claim 15, selected from at least one of the elements in the set comprising: a transmitter, a receiver, a sensor, a pressure sensor, a temperature sensor, and a support for any of the preceding elements.

19. A member according to claim 18, the member being a support for any of the above-specified elements, the element being secured to the support by snap-fastening.

20. A member according to claim 18, the member being a support for any of the above-specified elements, the support including a housing for receiving the element by insertion in an insertion direction that is substantially orthoradial when the support is secured to the wheel.

21. A member according to claim 15, weighing 15 g to 90 g.

22. A wheel for receiving a member, the wheel including a precoated layer of an adhesive presenting the following properties:
the breaking stress in traction of the adhesive is greater than 0.5 MPa at 80° C.;
the adhesive comprises at least one polymeric component of vitreous transition temperature below −50° C.; and
the adhesive comprises at least one other polymeric component of vitreous transition temperature above 100° C.

23. A wheel according to claim 22, in which the polymeric component belongs to the group of SBRs and polybutadienes.

24. A wheel according to claim 22, in which the other polymeric component is obtained by condensing an epoxy resin.

25. A wheel according to claim 22, in which the precoated layer of adhesive is carried by the radially-outer surface of an assembly groove of the wheel.

26. A method of assembling an assembly comprising a wheel, a member, and a tire, the method comprising the following steps:
a first step of using an adhesive to assemble the member and the wheel according to claim 1; and
a second step of assembling the tire on the wheel carrying the member;
wherein the two steps are separated by a duration that is predetermined in such a manner that the adhesive bond is sufficiently strong during the second step.

27. A method of assembly according to claim 26, in which the predetermined duration lies in the range 45 seconds to 55 seconds.

28. A method of assembly according to claim 26, in which the wheel fitted with the member is stored temporarily between the two steps.
